(19) United States
(12) Patent Application Publication
(10) Pub. No.: US 2024/0213629 A1
(43) Pub. Date: Jun. 27, 2024

(54) BATTERY AND METHOD FOR MANUFACTURING BATTERY

(71) Applicant: Panasonic Intellectual Property Management Co., Ltd., Osaka (JP)

(72) Inventors: KAZUYOSHI HONDA, Osaka (JP); KOICHI HIRANO, Osaka (JP); EIICHI KOGA, Hokkaido (JP); KAZUHIRO MORIOKA, Osaka (JP); AKIRA KAWASE, Osaka (JP)

(21) Appl. No.: 18/601,342

(22) Filed: Mar. 11, 2024

Related U.S. Application Data
(63) Continuation of application No. PCT/JP2022/025775, filed on Jun. 28, 2022.

(30) Foreign Application Priority Data
Sep. 28, 2021 (JP) 2021-158528

(51) Int. Cl. H01M 50/528; H01M 4/04; H01M 4/70; H01M 10/0562

(52) U.S. Cl. CPC H01M 50/528; H01M 4/0404; H01M 4/0407; H01M 4/70; H01M 10/0562; H01M 2300/0068

(57) ABSTRACT

A battery includes a power-generating element including a plurality of battery cells each including an electrode layer, a counter-electrode layer, and a solid electrolyte layer located between the electrode layer and the counter-electrode layer, a side surface insulating layer covering a side surface of the power-generating element from first to second ends of the power-generating element in a direction of laminating, a side surface conductor both connected to a counter-electrode layer located at the second end of the power-generating element and disposed along the side surface insulating layer, a counter-electrode collector terminal, both disposed at a first principal surface of the power-generating element located at the first end and connected to the side surface conductor, that is greater in thickness than a collector connected to the counter-electrode layer located at the second end, and an insulating layer disposed between the counter-electrode collector terminal and the first principal surface.

### BACKGROUND

### 1. Technical Field

The present disclosure relates to a battery and a method for manufacturing a battery.

### 2. Description of the Related Art

There have conventionally been known batteries in each of which a plurality of battery cells connected in series are connected in parallel to one another (see, for example, Japanese Unexamined Patent Application Publication No. 2013-120717 and Japanese Unexamined Patent Application Publication No. 2008-198492).

### SUMMARY

There has been demand for further improvement in battery characteristic of the conventional batteries.

One non-limiting and exemplary embodiment provides a high-performance battery and a method for manufacturing the same.

In one general aspect, the techniques disclosed here feature a battery including a power-generating element including a plurality of battery cells each including an electrode layer, a counter-electrode layer, and a solid electrolyte layer located between the electrode layer and the counter-electrode layer, the plurality of battery cells being electrically connected in series and laminated, a side surface insulating layer covering a side surface of the power-generating element from first to second ends of the power-generating element in a direction of laminating, a side surface conductor both connected to a counter-electrode layer located at the second end of the power-generating element and disposed along the side surface insulating layer, a counter-electrode collector terminal, both disposed at a first principal surface of the power-generating element located at the first end and connected to the side surface conductor, that is greater in thickness than a collector connected to the counter-electrode layer located at the second end, and an insulating layer disposed between the counter-electrode collector terminal and the first principal surface.

The present disclosure makes it possible to provide a high-performance battery and a method for manufacturing the same.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view of a battery according to Embodiment 1;

FIG. 2 is a top view of the battery according to Embodiment 1;

FIG. 3A is a cross-sectional view of an example of a battery cell included in a power-generating element according to Embodiment 1;

FIG. 3B is a cross-sectional view of another example of a battery cell included in the power-generating element according to Embodiment 1;

FIG. 3C is a cross-sectional view of another example of a battery cell included in the power-generating element according to Embodiment 1;

FIG. 4 is a cross-sectional view of the power-generating element according to Embodiment 1;

FIG. 5 is a cross-sectional view of a battery according to Embodiment 2;

FIG. 6 is a top view of the battery according to Embodiment 2;

FIG. 7 is a cross-sectional view of a battery according to Embodiment 3;

FIG. 8 is a cross-sectional view showing another example of a battery according to Embodiment 3;

FIG. 9 is a cross-sectional view of a battery according to Embodiment 4;

FIG. 10 is a top view of the battery according to Embodiment 4;

FIG. 11 is a cross-sectional view of a battery according to Embodiment 5;

FIG. 12 is a top view of the battery according to Embodiment 5;

FIG. 13 is a cross-sectional view showing another example of a battery according to Embodiment 5; and

FIG. 14 is a flow chart showing a method for manufacturing a battery according to an embodiment.

### DETAILED DESCRIPTIONS

### Brief Overview of the Present Disclosure

A battery according to an aspect of the present disclosure includes a power-generating element including a plurality of battery cells each including an electrode layer, a counter-electrode layer, and a solid electrolyte layer located between the electrode layer and the counter-electrode layer, the plurality of battery cells being electrically connected in series and laminated, a side surface insulating layer covering a side surface of the power-generating element from first to second ends of the power-generating element in a direction of laminating, a side surface conductor both connected to a counter-electrode layer located at the second end of the power-generating element and disposed along the side surface insulating layer, a counter-electrode collector terminal, both disposed at a first principal surface of the power-generating element located at the first end and connected to the side surface conductor, that is greater in thickness than a collector connected to the counter-electrode layer located at the second end, and an insulating layer disposed between the counter-electrode collector terminal and the first principal surface.

This makes it possible to achieve a high-performance battery. For example, this makes it possible to achieve a battery that is superior in mountability and reliability.

Specifically, the battery can be easily mounted by using the principal surface at which the counter-electrode collector terminal is provided. For example, the principal surface of the power-generating element is larger in area than the side surface of the power-generating element. The provision of the collector terminals at a large-area surface makes it possible to mount the battery in a large area, making it possible to enhance the reliability of connection. This also makes it possible to adjust the shapes and placement of the counter-electrode terminal according to a wiring layout of a printed circuit board, thus making it possible to also increase the degree of freedom of connection.

Further, this makes it possible to make positive-electrode and negative-electrode connections at an identical principal surface, thus allowing for compact mounting of the battery. For example, this makes it possible to reduce the size of a pattern (also referred to as “footprint”) of connecting terminals that is formed on the printed circuit board. Further, since the battery can be mounted with the principal surface of the power-generating element and the printed circuit board placed parallel to each other, low-profile mounting on the printed circuit board can be achieved.

Further, the electrode collector terminal is greater in thickness than the collector connected to the counter-electrode layer located at the second end and is high in electrical conductivity. This makes it possible to enhance large-current characteristics.

Further, for example, the battery according to the aspect of the present disclosure may further include an electrode collector terminal disposed at the first principal surface and connected to an electrode layer located at the first end.

Thus, since the counter-electrode collector terminal and the electrode collector terminal are provided at an identical principal surface, mountability can be further enhanced.

Further, for example, the battery according to the aspect of the present disclosure may further include an intermediate layer disposed between the electrode collector terminal and the first principal surface.

Thus, the provision of the intermediate layer brings about an effect of, for example, making the counter-electrode collector terminal and the electrode collector terminal equal in height or ensuring electrical insulation.

Further, for example, a height of the counter-electrode collector terminal from the first principal surface and a height of the electrode collector terminal from the first principal surface may be equal to each other.

This makes it possible to facilitate mounting on a flat surface of a substrate or other circuit boards, making it possible to also enhance the reliability of mounting.

Further, for example, the counter-electrode collector terminal and the electrode collector terminal may be arranged in this order along a direction away from the side surface in a planar view of the first principal surface.

This makes it possible to make the width of the counter-electrode collector terminal about equal to the width of the side surface conductor. This makes it possible to lower electric resistance, making it possible to extract a large current.

Further, for example, the counter-electrode collector terminal may surround the electrode collector terminal in a planar view of the first principal surface.

This makes it possible, for example, to use a wiring component or other components into which the counter-electrode collector terminal and the electrode collector terminal can be fitted together. This makes it possible to firmly and simply make a connection between the wiring component and the battery.

Further, for example, the battery according to the aspect of the present disclosure may further include a sealing member that exposes at least part of the counter-electrode collector terminal and at least part of the electrode collector terminal and seals the power-generating element, the side surface insulating layer, and the side surface conductor.

This makes it possible to protect the power-generating element, for example, from outside air and water, thus making it possible to further enhance the reliability of the battery.

Further, for example, each of the plurality of battery cells may include a collector, the electrode layer located at the first end may include an electrode collector, and a thickness of the electrode collector may be greater than a thickness of a collector included in one of the plurality of battery cells.

This makes it possible to use, as the electrode collector terminal, the electrode collector of the electrode layer at which the counter-electrode collector terminal is disposed. The electrode collector used as the electrode collector terminal is great in thickness and high in electrical conductivity. This makes it possible to enhance large-current characteristics.

Further, for example, the side surface conductor further may cover a second main surface of the power-generating element located at the second end.

Thus, since the side surface conductor wraps around the principal surface from the side surface of the power-generating element, the reliability of connection of the side surface conductor increases. For example, since a portion of the side surface conductor covering the principal surface gets caught on the power-generating element, it is hard for the side surface conductor to come off even in the presence of the application of an external force. This increases the area of contact between the side surface conductor and the counter-electrode layer, thus making it possible to decrease the resistance of contact between the side surface conductor and the counter-electrode layer and enhance large-current characteristics.

Further, for example, the side surface conductor may be a metal plate.

This makes it possible to easily form the side surface conductor with high mechanical strength.

Further, for example, the counter-electrode collector terminal may be part of the metal plate.

This makes it possible to integrally form the side surface conductor and the counter-electrode collector terminal. This makes it possible to reduce the number of components and reduce the number of steps of manufacturing the battery.

Further, for example, the side surface insulating layer may contain resin.

This makes it possible to increase impact resistance of the battery. This also makes it possible to relax stress that is applied to the battery due to changes in temperature of the battery or due to expansion and contraction of the battery during charging and discharging.

Further, for example, the side surface conductor may be greater in thickness than the collector connected to the counter-electrode layer located at the second end.

Thus, the side surface conductor is greater in thickness than the collector connected to the counter-electrode layer located at the second end and is high in electrical conductivity. This makes it possible to enhance large-current characteristics.

Further, a method for manufacturing a battery according to an aspect of the present disclosure includes preparing a plurality of battery cells each including an electrode layer, a counter-electrode layer, and a solid electrolyte layer located between the electrode layer and the counter-electrode layer, forming a layered product by laminating the plurality of battery cells so that an order of arrangement of the electrode layer, the counter-electrode layer, and the solid electrolyte layer of every one of the plurality of battery cells and an order of arrangement of the electrode layer, the counter-electrode layer, and the solid electrolyte layer of another of the plurality of battery cells are identical, covering a side surface of the layered product with an insulating member from first to second ends of the layered product, placing, along the insulating member, a conductor connected to a counter-electrode layer located at the second end of the layered product, and providing, via an insulating layer at a principal surface of the layered product located at the first end, a counter-electrode collector terminal connected to the conductor.

This makes it possible to manufacture the aforementioned high-performance battery.

The following describes embodiments in concrete terms with reference to the drawings.

It should be noted that the embodiments to be described below each illustrate a comprehensive and specific example. The numerical values, shapes, materials, constituent elements, placement and topology of constituent elements, steps, orders of steps, or other features that are shown in the following embodiments are just a few examples and are not intended to limit the present disclosure. Further, those of the constituent elements in the following embodiments which are not recited in an independent claim are described as optional constituent elements.

Further, the drawings are schematic views, and are not necessarily strict illustrations. Accordingly, for example, the drawings are not necessarily to scale. Further, in the drawings, substantially identical components are given identical reference signs, and a repeated description may be omitted or simplified.

Further, terms such as “parallel” or “orthogonal” used herein to show the way in which elements are interrelated, terms such as “rectangle” or “cuboid” used herein to show the shape of an element, and ranges of numerical values as used herein are not expressions that represent only exact meanings but expressions that are meant to also encompass substantially equivalent ranges, e.g. differences of approximately several percent.

Further, in the present specification and drawings, the x axis, the y axis, and the z axis represent the three axes of a three-dimensional orthogonal coordinate system. In a case where the planimetric shape of a power-generating element of a battery is a rectangle, the x axis and the y axis correspond to directions parallel with a first side of the rectangle and a second side orthogonal to the first side, respectively. The z axis corresponds to a direction of laminating of a plurality of battery cells included in the power-generating element.

Further, the term “direction of laminating” as used herein corresponds to a direction normal to principal surfaces of a collector and an active material layer. Further, the term “planar view” as used herein means a case where the battery is viewed from a direction perpendicular to a principal surface of a power-generating element, unless otherwise noted, e.g. in a case where the term is used alone. In the case of a phrase “planar view of a surface” such as “planar view of a first side surface”, it means a case where the “surface” is viewed from the front.

Further, the terms “above” and “below” as used herein do not refer to an upward direction (upward in a vertical direction) and a downward direction (downward in a vertical direction) in absolute space recognition, but are used as terms that are defined by a relative positional relationship on the basis of an order of laminating in a laminating configuration. Further, the terms “above” and “below” are applied not only in a case where two constituent elements are placed at a spacing from each other with another constituent element present between the two constituent elements, but also in a case where two constituent elements touch each other by being placed in close contact with each other. In the following description, the negative side of the z axis is referred to as “below” or “lower”, and the positive side of the z axis is referred to as “above” or “upper”.

Further, the expression “covering A” as used herein means covering at least part of “A”. That is, the expression “covering A” encompasses not only a case of “covering the whole of A” but also a case of “covering only part of A”. Examples of “A” include side surfaces, principal surfaces, or other surfaces of predetermined members such as layers or terminals.

Further, the ordinal numbers such as “first” and “second” as used herein do not mean the number or order of constituent elements but are used for the purpose of avoiding confusion between constituent elements of the same type and distinguishing between them, unless otherwise noted.

### Embodiment 1

In the following, a configuration of a battery according to Embodiment 1 is described.

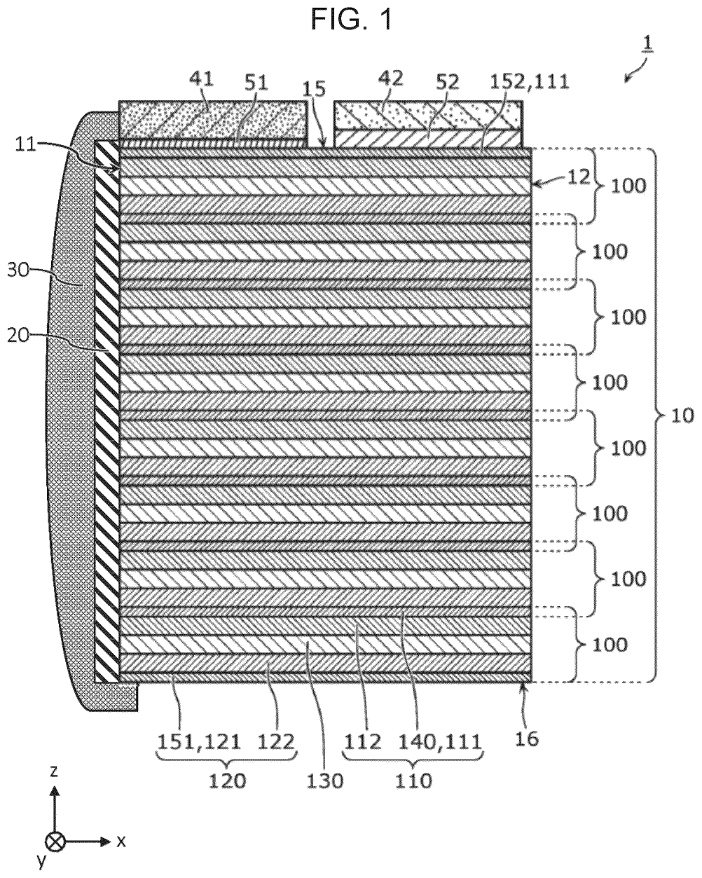

FIG. 1 is a cross-sectional view of a battery 1 according to the present embodiment. As shown in FIG. 1, the battery 1 includes a power-generating element 10, a side surface insulating layer 20, a side surface conductor 30, a counter-electrode collector terminal 41, an electrode collector terminal 42, a counter-electrode intermediate layer 51, and an electrode intermediate layer 52. The battery 1 is for example an all-solid-state battery.

### 1. Power-Generating Element

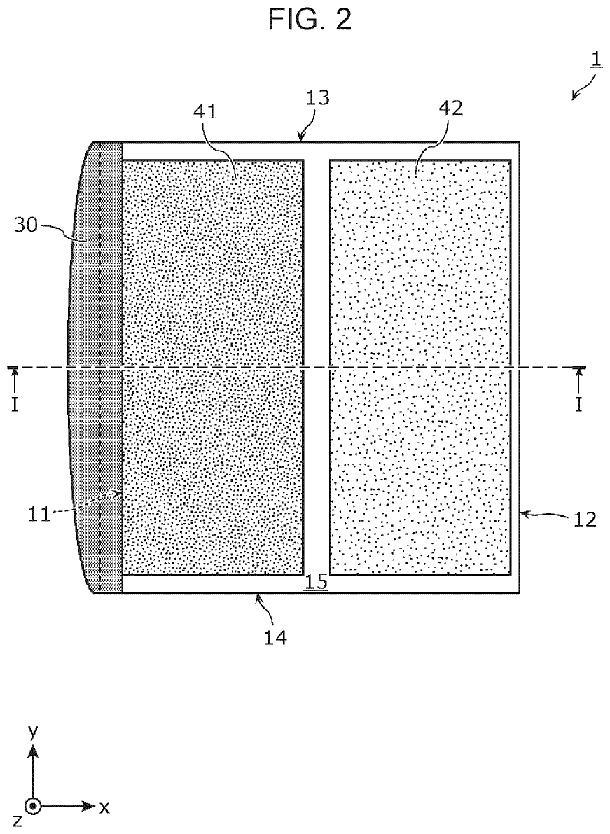

First, a configuration of the power-generating element 10 is described in concrete terms with reference to FIGS. 1 and 2. FIG. 2 is a top view of the battery 1 according to the present embodiment. It should be noted that FIG. 1 represents a cross-section taken along line I-I in FIG. 2.

The planimetric shape of the power-generating element 10 is for example a rectangle as shown in FIG. 2. That is, the shape of the power-generating element 10 is a flat cuboid. The term “flat” here means that a thickness (i.e. a length in a z-axis direction) is shorter than each side (i.e. lengths in x-axis and y-axis directions) or the maximum width of a principal surface. The planimetric shape of the power-generating element 10 may be another polygon such as a regular square, a hexagon, or an octagon or may be a circle or an ellipse. It should be noted that cross-sectional views such as FIG. 1 illustrate the thickness of each layer with exaggeration to make a layer structure of the power-generating element 10 easier to understand.

As shown in FIGS. 1 and 2, the power-generating element 10 includes four side surfaces 11, 12, 13, and 14 and two principal surfaces 15 and 16. In the present embodiment, the side surfaces 11, 12, 13, and 14 and the principal surfaces 15 and 16 are each a flat surface.

The side surfaces 11 and 12 face away from each other and are parallel to each other. The side surfaces 13 and 14 face away from each other and are parallel to each other. The side surfaces 11, 12, 13, and 14 are for example cut surfaces formed by en-bloc cutting of a layered product composed of a plurality of battery cells 100.

The principal surface 15 is an example of the first principal surface. The principal surface 16 is an example of the second principal surface. The principal surfaces 15 and 16 face away from each other and are parallel to each other. The principal surface 15 is the uppermost surface of the power-generating element 10. The principal surface 16 is the lowermost surface of the power-generating element 10. The principal surfaces 15 and 16 are larger in area than the side surfaces 11, 12, 13, and 14.

As shown in FIG. 1, the power-generating element 10 includes the plurality of battery cells 100. Each of the battery cells 100 is a minimum constituent battery and is also referred to as “unit cell”. The plurality of battery cells 100 are electrically connected in series and laminated. In the present embodiment, all of the battery cells 100 that the power-generating element 10 includes are electrically connected in series. Although, in the example shown in FIG. 1, the number of battery cells 100 that the power-generating element 10 includes is 8, this is not intended to impose any limitation. For example, the number of battery cells 100 that the power-generating element 10 includes may be an even number such a 2 or 4 or may be an odd number such as 3 or 5.

Each of the plurality of battery cells 100 includes an electrode layer 110, a counter-electrode layer 120, and a solid electrolyte layer 130. The electrode layer 110 includes an electrode collector 111 and an electrode active material layer 112. The counter-electrode layer 120 includes a counter-electrode collector 121 and a counter-electrode active material layer 122. In each of the plurality of battery cells 100, the electrode collector 111, the electrode active material layer 112, the solid electrolyte layer 130, the counter-electrode active material layer 122, and the counter-electrode collector 121 are laminated in this order along the z axis.

It should be noted that the electrode layer 110 is one of positive-electrode and negative-electrode layers of the battery cell 100. The counter-electrode layer 120 is the other of the positive-electrode and negative-electrode layers of the battery cell 100. The following gives a description by taking as an example a case where the electrode layer 110 is the negative-electrode layer and the counter-electrode layer 120 is the positive-electrode layer.

In the present embodiment, two of the plurality of battery cells 100 that are adjacent to each other in the direction of laminating share a collector with each other. That is, the electrode collector 111 of one of the tow battery cells 100 and the counter-electrode collector 121 of the other of the two battery cells 100 constitute one intermediate layer collector 140.

Specifically, an electrode active material layer 112 is laminated on a lower surface of the intermediate layer collector 140. A counter-electrode active material layer 122 is laminated on an upper surface of the intermediate layer collector 140. The intermediate layer collector 140 is also referred to as “bipolar collector”.

FIG. 1 shows end layer collectors 151 and 152 located at both ends of the power-generating element 10 in the direction of laminating. The end layer collector 152, which is located at an upper end that is a first end in the direction of laminating, is an electrode collector 111. An electrode active material layer 112 is disposed on a lower surface of the electrode collector 111. The end layer collector 151, which is located at a lower end that is a second end in the direction of laminating, is a counter-electrode collector 121. A counter-electrode active material layer 122 is disposed on an upper surface of the counter-electrode collector 121.

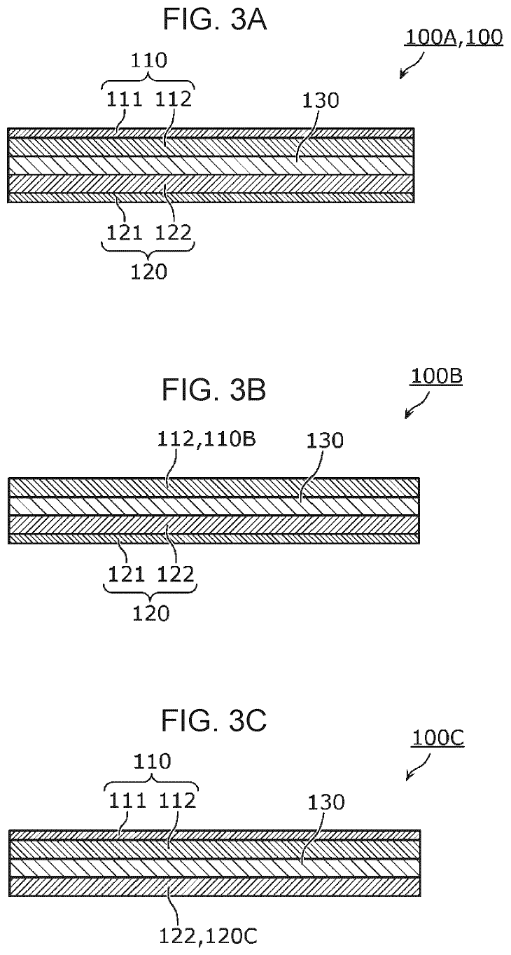

In the following, the layers of a battery cell 100 are described with reference to FIG. 3A. FIG. 3A is a cross-sectional view of a battery cell 100 included in the power-generating element 10 according to the present embodiment.

The electrode collector 111 and the counter-electrode collector 121 shown in FIG. 3A are each the intermediate layer collector 140 or the end layer collector 151 or 152 shown in FIG. 1. The electrode collector 111 and the counter-electrode collector 121 are each a foil-like, plate-like, or net-like member possessing electrical conductivity. The electrode collector 111 and the counter-electrode collector 121 may each for example be a thin film possessing electrical conductivity. Usable examples of a material of which the electrode collector 111 and the counter-electrode collector 121 are made include metals such as stainless steel (SUS), aluminum (Al), copper (Cu), and nickel (Ni). The electrode collector 111 and the counter-electrode collector 121 may be made of different materials.

Examples of the thicknesses of the electrode collector 111 and the counter-electrode collector 121 include, but are not limited to, thicknesses greater than or equal to 5 μm and less than or equal to 100 μm. The electrode active material layer 112 is in contact with a principal surface of the electrode collector 111. It should be noted that the electrode collector 111 may include a collector layer, provided in a portion that is in contact with the electrode active material layer 112, that is a layer containing an electrically conductive material. The counter-electrode active material layer 122 is in contact with a principal surface of the counter-electrode collector 121. It should be noted that the counter-electrode collector 121 may include a collector layer, provided in a portion that is in contact with the counter-electrode active material layer 122, that is a layer containing an electrically conductive material.

The electrode active material layer 112 is disposed on a principal surface of the electrode collector 111 that faces toward the counter-electrode layer 120. The electrode active material layer 112 contains, for example, a negative-electrode active material as an electrode material. The electrode active material layer 112 is placed opposite the counter-electrode active material layer 122.

Usable examples of the negative-electrode active material contained in the electrode active material layer 112 include negative-electrode active materials such as graphite and metallic lithium. Usable examples of materials for the negative-electrode active material include various types of material from and into which ions of lithium (Li), magnesium (Mg), or other substances can be desorbed and inserted.

Further, a possible example of a material contained in the electrode active material layer 112 may be a solid electrolyte such as an inorganic solid electrolyte. A usable example of the inorganic solid electrolyte is a sulfide solid electrolyte or an oxide solid electrolyte. A usable example of the sulfide solid electrolyte is a mixture of lithium sulfide (Li₂S) and diphosphorous pentasulfide (P₂S₅). Further, a possible example of a material contained in the electrode active material layer 112 may be an electrical conducting material such as acetylene black or a binder such as polyvinylidene fluoride.

The electrode active material layer 112 is fabricated by preparing a paste of paint into which the materials to be contained in the electrode active material layer 112 were kneaded together with a solvent, spreading the paste of paint over the principal surface of the electrode collector 111, and drying the paste of paint. For increased density of the electrode active material layer 112, an electrode layer 110 (also referred to as “electrode plate”) including the electrode active material layer 112 and the electrode collector 111 may be pressed after the drying. Examples of the thickness of the electrode active material layer 112 include, but are not limited to, thicknesses greater than or equal to 5 μm and less than or equal to 300 μm.

The counter-electrode active material layer 122 is disposed on a principal surface of the counter-electrode collector 121 that faces toward the electrode layer 110. The counter-electrode active material layer 122 is a layer containing a positive-electrode material such as an active material. The positive-electrode material is a material that is opposite in polarity to a negative-electrode material. The counter-electrode active material layer 122 contains, for example, a positive-electrode active material.

Usable examples of the positive-electrode active material contained in the counter-electrode active material layer 122 include positive-electrode active materials such as a lithium cobalt oxide complex oxide (LCO), a lithium nickel oxide complex oxide (LNO), a lithium manganese oxide complex oxide (LMO), a lithium-manganese-nickel complex oxide (LMNO), a lithium-manganese-cobalt complex oxide (LMCO), a lithium-nickel-cobalt complex oxide (LNCO), a lithium-nickel-manganese-cobalt complex oxide (LNMCO). Usable examples of materials for the positive-electrode active material include various types of material from and into which ions of Li, Mg, or other substances can be desorbed and inserted.

Further, a possible example of a material contained in the counter-electrode active material layer 122 may be a solid electrolyte such as an inorganic solid electrolyte. A usable example of the inorganic solid electrolyte is a sulfide solid electrolyte or an oxide solid electrolyte. A usable example of the sulfide solid electrolyte is a mixture of Li₂S and P₂S₅. The positive-electrode active material may have a surface coated with the solid electrolyte. Further, a possible example of a material contained in the counter-electrode active material layer 122 may be an electrical conducting material such as acetylene black or a binder such as polyvinylidene fluoride.

The counter-electrode active material layer 122 is fabricated by preparing a paste of paint into which the materials to be contained in the counter-electrode active material layer 122 were kneaded together with a solvent, spreading the paste of paint over the principal surface of the counter-electrode collector 121, and drying the paste of paint. For increased density of the counter-electrode active material layer 122, a counter-electrode layer 120 (also referred to as “counter-electrode plate”) including the counter-electrode active material layer 122 and the counter-electrode collector 121 may be pressed after the drying. Examples of the thickness of the counter-electrode active material layer 122 include, but are not limited to, thicknesses greater than or equal to 5 μm and less than or equal to 300 μm.

The solid electrolyte layer 130 is disposed between the electrode active material layer 112 and the counter-electrode active material layer 122. The solid electrolyte layer 130 is in contact with both the electrode active material layer 112 and the counter-electrode active material layer 122. The solid electrolyte layer 130 is a layer containing an electrolyte material. A usable example of the electrolyte material is a common publicly-known electrolyte for use in a battery. The solid electrolyte layer 130 may have a thickness greater than or equal to 5 μm and less than or equal to 300 μm or greater than or equal to 5 μm and less than or equal to 100 μm.

The solid electrolyte layer 130 contains a solid electrolyte. A usable example of the solid electrolyte is a solid electrolyte such as an inorganic solid electrolyte. A usable example of the inorganic solid electrolyte is a sulfide solid electrolyte or an oxide solid electrolyte. A usable example of the sulfide solid electrolyte is a mixture of Li₂S and P₂S₅. It should be noted that the solid electrolyte layer 130 may contain a binder such as polyvinylidene fluoride in addition to the electrolyte material.

In the present embodiment, the electrode active material layer 112, the counter-electrode active material layer 122, and the solid electrolyte layer 130 are maintained in a parallel plate state. This makes it possible to reduce the occurrence of a crack or a collapse due to bending. It should be noted that the electrode active material layer 112, the counter-electrode active material layer 122, and the solid electrolyte layer 130 may be smoothly bent together.

Further, in the present embodiment, an end face of the counter-electrode collector 121 located at the side surface 11 and an end face of the electrode collector 111 located at the side surface 11 are even with each other when viewed from the z-axis direction. The same applies to end faces of the counter-electrode collector 121 and the electrode collector 111 located at the side surface 12.

More specifically, in the battery cell 100, the electrode collector 111, the electrode active material layer 112, the solid electrolyte layer 130, the counter-electrode active material layer 122, and the counter-electrode collector 121 are the same in shape and size as one another and have their contours in conformance with one another. That is, the battery cell 100 has the shape of a flat cuboidal plate.

As mentioned, above, in the power-generating element 10 according to the present embodiment, as shown in FIG. 1, the plurality of battery cells 100 share intermediate layer collectors 140. Such a power-generating element 10 is formed by laminating not only the battery cell 100 shown in FIG. 3A but also a combination of battery cells 100B and 100C shown in FIGS. 3B and 3C. It should be noted that the battery cell 100 shown in FIG. 3A is described as a battery cell 100A here.

The battery cell 100B shown in FIG. 3B has a configuration in which the electrode collector 111 is excluded from the battery cell 100A shown in FIG. 3A. That is, the battery cell 100B includes an electrode layer 110B composed solely of an electrode active material layer 112.

The battery cell 100C shown in FIG. 3C has a configuration in which the counter-electrode collector 121 is excluded from the battery cell 100A shown in FIG. 3A. That is, the battery cell 100C includes a counter-electrode layer 120C composed solely of a counter-electrode active material layer 122.

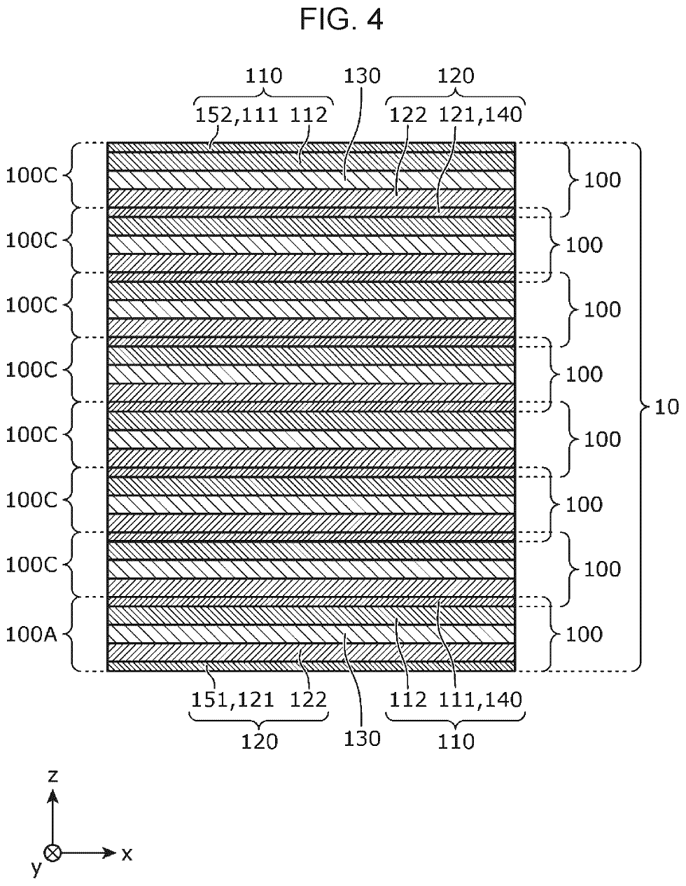

FIG. 4 is a cross-sectional view showing the power-generating element 10 according to the present embodiment. FIG. 4 is a diagram showing only the power-generating element 10 of FIG. 1. As shown in FIG. 4, the battery cell 100A is disposed at the lowermost layer, and a plurality of the battery cells 100C are sequentially laminated upward in the same orientation. In this way, the power-generating element 10 is formed.

It should be noted that this is not the only method for forming a power-generating element 10. For example, the battery cell 100A may be placed at the uppermost layer after a plurality of the battery cells 100B have been laminated in the same orientation. Further, for example, the battery cell 100A may be placed in a position different from both the uppermost layer and the lowermost layer. Further, a plurality of the battery cells 100A may be used. Further, a unit of two battery cells 100 sharing a collector with each other may be formed by coating both sides of one collector, and the unit thus formed may be laminated.

As noted above, in the power-generating element 10 according to the present embodiment, all of the battery cells 100 are connected in series, and there are no battery cells connected in parallel. This makes it possible to achieve the high-voltage battery 1.

### 2. Side Surface Insulating Layer

Next, the side surface insulating layer 20 is described.

The side surface insulating layer 20 covers the side surface 11 of the power-generating element 10 from lower to upper ends of the power-generating element 10. For example, the side surface insulating layer 20 covers the whole of the side surface 11. This allows the side surface insulating layer 20 to ensure insulation of the side surface conductor 30 from the electrode active material layer 112, the counter-electrode active material layer 122, the solid electrolyte layer 130, and the intermediate layer collector 140.

The side surface insulating layer 20 is made of an insulating material possessing electrical insulating properties. For example, the side surface insulating layer 20 contains resin. Examples of the resin include, but are not limited to, epoxy resin. As the insulating material, an inorganic material may be used. A usable insulating material is selected on the basis of various properties such as flexibility, gas barrier properties, impact resistance, and thermal resistance.

It should be noted that the side surface insulating layer 20 does not need to cover part of the side surface 11. For example, the side surface insulating layer 20 does not need to cover an end face of the end layer collector 151, which is located at the lowermost layer of the power-generating element 10.

### 3. Side Surface Conductor

Next, the side surface conductor 30 is described.

The side surface conductor 30 is connected to a counter-electrode layer 120 located at the second end of the power-generating element 10 and disposed along the side surface insulating layer 20. Specifically, the side surface conductor 30 covers the principal surface 16 of the power-generating element 10 and is connected to the end layer collector 151, which is located at the lower end of the power-generating element 10, i.e. to a counter-electrode collector 121. The side surface conductor 30 is connected to the counter-electrode collector terminal 41, which is disposed at the principal surface 15 of the power-generating element 10.

At the side surface 11 of the power-generating element 10, the side surface conductor 30 are not in contact with the electrode active material layer 112, the solid electrolyte layer 130, the counter-electrode active material layer 122, the intermediate layer collector 140, and the end layer collector 152, which is located at the upper end. This makes it possible to reduce the risk of a short circuit of the power-generating element 10.

The side surface conductor 30 covers substantially the entirety of the side surface 11. Specifically, the width (i.e. the length in the y-axis direction) of the side surface conductor 30 is substantially equal to the with (i.e. the length in the y-axis direction) of the side surface 11. This makes it possible to enhance the electrical conductivity of the side surface conductor 30. Specifically, since an electric current flows through the side surface conductor 30 along the direction of laminating, the area of a cross-section orthogonal to the direction of flow of an electric current increases. This makes it possible to enhance large-current characteristics.

The side surface conductor 30 is made, for example, of a resin material possessing electrical conductivity. Alternatively, the side surface conductor 30 may be made of a metallic material such as solder. A usable electrically conductive material is selected on the basis of various properties such as flexibility, gas barrier properties, impact resistance, thermal resistance, and solder wettability.

### 4. Collector Terminals

Next, the counter-electrode collector terminal 41 and the electrode collector terminal 42 are described.

The counter-electrode collector terminal 41 is connected to the side surface conductor 30. The counter-electrode collector terminal 41 is one of external connecting terminals of the battery 1 and, in the present embodiment, is a positive-electrode lead terminal. As shown in FIG. 1, the counter-electrode collector terminal 41 is disposed over the principal surface 15 of the power-generating element 10 with the counter-electrode intermediate layer 51 sandwiched therebetween. The counter-electrode collector terminal 41 is in contact with an upper end of the side surface conductor 30.

The electrode collector terminal 42 is connected to the end layer collector 152, which is an electrode collector 111. The electrode collector terminal 42 is one of the external connecting terminals of the battery 1 and, in the present embodiment, is a negative-electrode lead terminal. As shown in FIG. 1, the electrode collector terminal 42 is disposed over the principal surface 15 of the power-generating element 10 with the electrode intermediate layer 52 sandwiched therebetween. For example, the electrode intermediate layer 52 is a conductive layer, and the electrode collector terminal 42 is connected via the electrode intermediate layer 52 to the electrode collector 111 located at the uppermost layer.

Thus, in the present embodiment, the counter-electrode collector terminal 41 and the electrode collector terminal 42 are provided at the identical principal surface 15 of the power-generating element 10. As shown in FIG. 2, the counter-electrode collector terminal 41 and the electrode collector terminal 42 are arranged in this order along a direction from the side surface 11 toward the side surface 12 (i.e. a positive direction of the x axis). Specifically, in a case where the principal surface 15 is virtually divided into two equal regions along a virtual line parallel to the y axis, the counter-electrode collector terminal 41 is provided in a region on the negative side of the x axis, and the electrode collector terminal 42 is provided in a region on the positive side of the x axis.

For example, the width (i.e. the length in the y-axis direction) of the counter-electrode collector terminal 41 is greater than or equal to half of the width (i.e. the length in the y-axis direction) of the side surface 11. The width of the counter-electrode collector terminal 41 can be made about equal to the width (i.e. the length in the y-axis direction) of the side surface conductor 30. This makes it possible to widen a width with respect to the direction of flow of electricity from the side surface conductor 30 to the counter-electrode collector terminal 41, thus making it possible to lower resistance. This is effective in extracting a large current.

The counter-electrode collector terminal 41 and the electrode collector terminal 42 are each made of a material possessing electrical conductivity. For example, the counter-electrode collector terminal 41 and the electrode collector terminal 42 are metal foil or metal plates made of metal such as copper, aluminum, or stainless steel. Alternatively, the counter-electrode collector terminal 41 and the electrode collector terminal 42 may be hardened solder.

### 5. Intermediate Layers

Next, the counter-electrode intermediate layer 51 and the electrode intermediate layer 52 are described.

The counter-electrode intermediate layer 51 is disposed between the counter-electrode collector terminal 41 and the principal surface 15. In the present embodiment, since the principal surface 15 is a principal surface of an electrode collector 111, it is necessary to ensure insulation between the counter-electrode collector terminal 41 and the principal surface 15. For this reason, the counter-electrode intermediate layer 51 is an insulating layer.

The electrode intermediate layer 52 is provided between the electrode collector terminal 42 and the principal surface 15. In the present embodiment, since the principal surface 15 is a principal surface of an electrode collector 111, it is not necessary to ensure insulation between the electrode collector terminal 42 and the principal surface 15. For this reason, the electrode intermediate layer 52 may be a conductive layer. Further, the electrode intermediate layer 52 does not need to be provided.

In the present embodiment, since the counter-electrode intermediate layer 51 is needed between the counter-electrode collector terminal 41 and the principal surface 15, a height of the counter-electrode collector terminal 41 from the principal surface 15 and a height of the electrode collector terminal 42 from the principal surface 15 tend to be different from each other. Providing the electrode intermediate layer 52 and adjusting its thickness makes it possible, for example, to make the electrode collector terminal 42 and the counter-electrode collector terminal 41 equal in height from the principal surface 15. Alternatively, it is possible to make the thickness of the electrode collector terminal 42 equal to the total thickness of the counter-electrode collector terminal 41 and the counter-electrode intermediate layer 51 without providing the electrode intermediate layer 52. Making the counter-electrode collector terminal 41 and the electrode collector terminal 42 equal in height from the principal surface 15 makes it possible to easily mount the battery 1 parallel to a substrate (not illustrated).

Although the planimetric shape and size of the counter-electrode intermediate layer 51 are identical to those of the counter-electrode collector terminal 41, this is not intended to impose any limitation. For example, the counter-electrode intermediate layer 51 may be larger than the counter-electrode collector terminal 41 in planar view. The counter-electrode intermediate layer 51 may be in contact with the electrode intermediate layer 52 or the electrode collector terminal 42.

Although the planimetric shape and size of the electrode intermediate layer 52 are identical to those of the electrode collector terminal 42, this is not intended to impose any limitation. For example, the electrode intermediate layer 52 may be larger or smaller than the electrode collector terminal 42 in planar view. Part of the electrode collector terminal 42 may be in contact with the principal surface 15.

The counter-electrode intermediate layer 51 is made of an insulating material possessing electrical insulating properties. For example, the counter-electrode intermediate layer 51 contains resin. Examples of the resin include, but are not limited to, epoxy resin. As the insulating material, an inorganic material may be used.

The electrode intermediate layer 52 is made of an electrical conducting material possessing electrical conductivity. The electrode intermediate layer 52 can for example be made of metal, conductive resin, or other materials.

In a case where the electrode intermediate layer 52 is an insulating layer, the counter-electrode intermediate layer 51 and the electrode intermediate layer 52 may be a single insulating layer. For example, an insulating layer covering substantially the whole of the principal surface 15 may be provided as the counter-electrode intermediate layer 51 and the electrode intermediate layer 52. In a case where the electrode intermediate layer 52 is an insulating layer, an electrical connection can be made by bringing the electrode collector terminal 42 into contact with the electrode collector 111 located at the uppermost layer.

The counter-electrode intermediate layer 51 and the electrode intermediate layer 52 may have additional functions such as impact resistance, anticorrosion, and waterproofness in addition to ensuring insulation. The counter-electrode intermediate layer 51 and the electrode intermediate layer 52 can be made of a material suited for these functions. The counter-electrode intermediate layer 51 and the electrode intermediate layer 52 may each have a laminated structure of a plurality of different materials.

### 6. Conclusion

As noted above, in the battery 1 according to the present embodiment, the plurality of battery cells 100 are laminated in series. This makes it possible to achieve the high-energy density and high-voltage battery 1. Further, the counter-electrode collector terminal 41 and the electrode collector terminal 42 are provided at the principal surface 15 of the power-generating element 10. That is, both positive-electrode and negative-electrode terminals needed for current extraction from the power-generating element 10 are provided at the identical principal surface 15. For example, the principal surface 15 is larger in area than the side surfaces 11, 12, 13, and 14. The provision of terminals at a large-area surface makes it possible to mount the battery 1 in a large area, making it possible to enhance the reliability of connection. This also makes it possible to adjust the shape and placement of a terminal according to a wiring layout of a substrate on which the battery 1 is to be mounted, thus making it possible to also increase the degree of freedom of connection.

Further, the provision of both positive-electrode and negative-electrode terminals at an identical principal surface allows for compact mounting of the battery 1. For example, this makes it possible to reduce the size of a pattern (also referred to as “footprint”) of connecting terminals that is formed on a printed circuit board. Further, since the battery 1 can be mounted with the principal surface 15 and the printed circuit board placed parallel to each other, low-profile mounting on the printed circuit board can be achieved. The mounting can involve the use of reflow solder connections. The battery 1 thus achieved can be superior in mountability.

Further, the covering of the side surface 11 of the power-generating element 10 by the side surface insulating layer 20 makes it possible to form the side surface conductor 30, which extends from the counter-electrode collector 121 located at the lower end of the power-generating element 10 to the upper end of the power-generating element 10. Making the width of the side surface conductor 30 about equal to the width of the side surface 11 makes it possible to ensure a large area of a cross-section orthogonal to the direction of flow of an electric current. This makes it possible to pass a large current through the side surface conductor 30, thus making it possible to achieve a battery 1 that is superior in large-current characteristic.

Further, the side surface conductor 30, which is used routing from the counter-electrode collector 121 located at the lower end to the upper end, is formed at the side surface 11 of the power-generating element 10 with the side surface insulating layer 20 sandwiched therebetween. Bringing the side surface insulating layer 20 into close contact with the side surface 11 and bringing the side surface conductor 30 into close contact with the side surface insulating layer 20 allows for a compact structure for routing. This makes it possible to increase energy density per volume, making it possible to achieve the high-energy density battery 1.

Further, since the electrode collector terminal 42, which is a member that is different from the electrode collector 111 located at the uppermost layer, is provided, current crowding into the electrode collector 111 located at the uppermost layer can be inhibited. Similarly, since the counter-electrode collector terminal 41, which is a member that is different from the counter-electrode collector 121 located at the lowermost layer, is provided, current crowding into the counter-electrode collector 121 located at the lowermost layer can be inhibited. In the case of an occurrence of current crowding into the electrode collector 111 or the counter-electrode collector 121, the rise in temperature due to heat generated by an electric current may cause delamination of the electrode collector 111 or the counter-electrode collector 121 and may facilitate deterioration of the battery cell 100 located at the uppermost layer or the lowermost layer. According to the present embodiment, as a current pathway from each battery cell 100, the counter-electrode collector terminal 41 and the electrode collector terminal 42 are used. This makes it possible to inhibit current crowding into the electrode collector 111 located at the uppermost layer and the counter-electrode collector 121 located at the lowermost layer, making it possible to enhance the reliability of the battery 1.

Further, the side surfaces 11, 12, 13, and 14 of the power-generating element 10 of the battery 1 can be made flat side surfaces, for example, by en-bloc cutting of the plurality of battery cells 100 laminated. Using en-bloc cutting causes the areas of the electrode layer 110, the counter-electrode layer 120, and the solid electrolyte layer 130 to be accurately determined without a gradual increase or decrease in film thickness at the beginning and end of coating of each layer. This reduces variations in the capacity of the battery cells 100, thus making it possible to improve the accuracy of battery capacity.

### Embodiment 2

The following describes Embodiment 2.

A battery according to Embodiment 2 differs from the battery 1 according to Embodiment 1 in shape of a counter-electrode collector terminal and an electrode collector terminal. The following gives a description with a focus on differences from Embodiment 1, and omits or simplifies a description of common features.

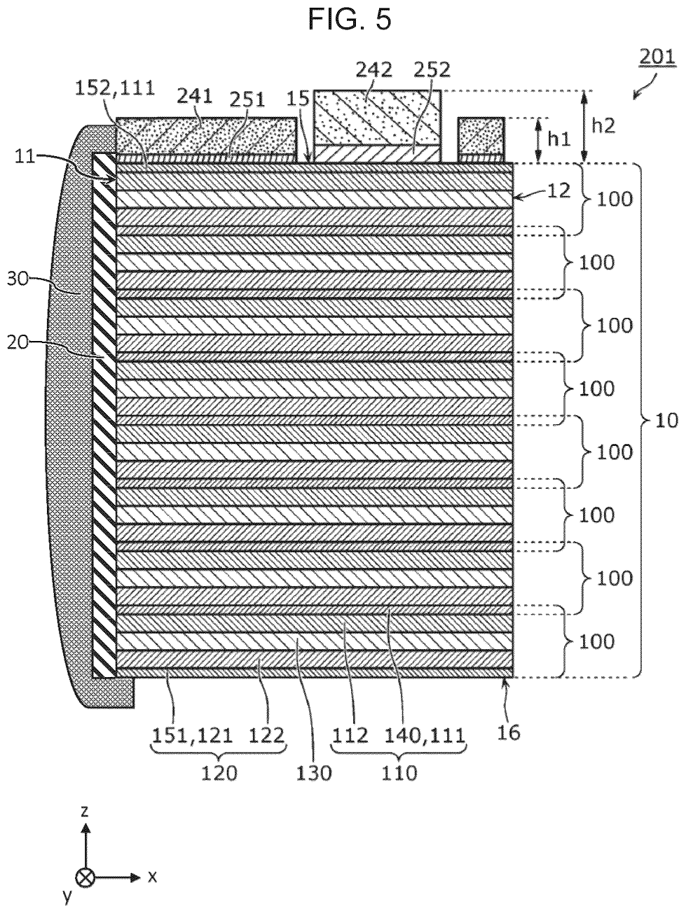

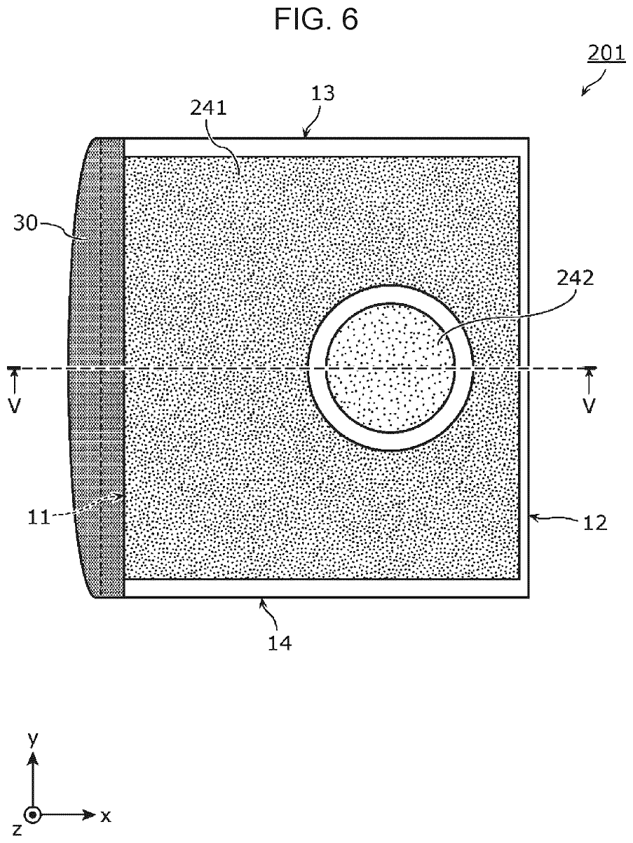

FIG. 5 is a cross-sectional view of a battery 201 according to the present embodiment. FIG. 6 is a top view of the battery 201 according to the present embodiment. It should be noted that FIG. 5 represents a cross-section taken along line V-V in FIG. 6. As shown in FIGS. 5 and 6, in comparison with the battery 1 according to Embodiment 1, the battery 201 includes a counter-electrode collector terminal 241, an electrode collector terminal 242, a counter-electrode intermediate layer 251, and an electrode intermediate layer 252 instead of the counter-electrode collector terminal 41, the electrode collector terminal 42, the counter-electrode intermediate layer 51, and the electrode intermediate layer 52.

As shown in FIG. 6, the counter-electrode collector terminal 241 surrounds the electrode collector terminal 242 in a planar view of the principal surface 15. A gas is provided between the counter-electrode collector terminal 241 and the electrode collector terminal 242 so that the counter-electrode collector terminal 241 and the electrode collector terminal 242 do not make contact with each other. The counter-electrode collector terminal 241 surrounds the whole circumference of the electrode collector terminal 242. Alternatively, the counter-electrode collector terminal 241 may surround only part of the electrode collector terminal 242. For example, the counter-electrode collector terminal 241 may surround positive and negative side of the electrode collector terminal 242 in the y-axis direction and a negative side of the electrode collector terminal 242 in the x-axis direction and does not need to surround a positive side of the electrode collector terminal 242 in the x-axis direction.

The electrode collector terminal 242 is provided in a position displaced from the center of the principal surface 15 toward the positive side of the x-axis. Alternatively, the electrode collector terminal 242 may be provided in the center of the principal surface 15. Alternatively, the electrode collector terminal 242 may be provided in a corner portion of the principal surface 15.

The planimetric shape of the electrode collector terminal 242 is a circle but is not limited to particular shapes. The counter-electrode collector terminal 241 and the electrode collector terminal 242 may each have a shape that corresponds to the terminal shape of an external wire (not illustrated) to which they are connected.

As shown in FIG. 5, a height h2 of the electrode collector terminal 242 from the principal surface 15 is greater than a height h1 of the counter-electrode collector terminal 241 from the principal surface 15. Thus, for example, a portion of the electrode collector terminal 242 that projects further than the counter-electrode collector terminal 241 can be used for connection to an external wire (not illustrated). This makes it possible to increase the area of contact between the electrode collector terminal 242 and the external wire, thus making it possible to lower contact resistance and increase the robustness of mechanical connection strength.

Further, the difference in height between the electrode collector terminal 242 and the counter-electrode collector terminal 241 makes it possible to place the electrode collector terminal 242 and the counter-electrode collector terminal 241 at a long distance from each other. This makes it possible to reduce the occurrence of a short circuit.

The counter-electrode intermediate layer 251 and the electrode intermediate layer 252 are formed in shapes that correspond to those of the counter-electrode collector terminal 241 and the electrode collector terminal 242, respectively. The electrode intermediate layer 252 does not need to be provided.

### Embodiment 3

The following describes Embodiment 3.

A battery according to Embodiment 3 differs from the battery 1 according to Embodiment 1 in that the battery according to Embodiment 3 does not include an electrode collector terminal. The following gives a description with a focus on differences from Embodiment 1, and omits or simplifies a description of common features.

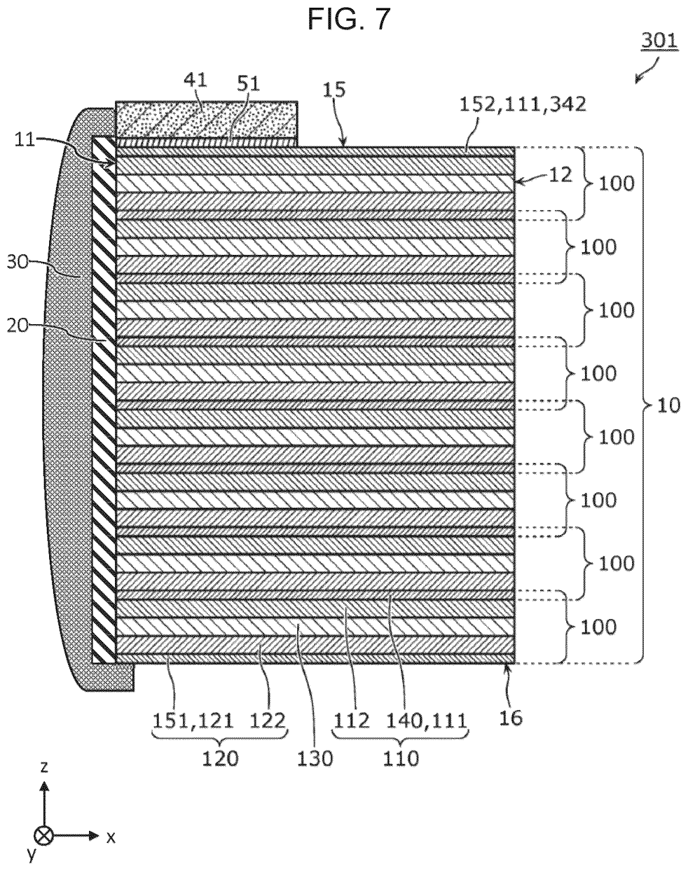

FIG. 7 is a cross-sectional view of a battery 301 according to the present embodiment. As shown in FIG. 7, in comparison with the battery 1 according to Embodiment 1, the battery 301 does not include the electrode collector terminal 42 or the electrode intermediate layer 52.

In the battery 301 according to the present embodiment, part of the electrode collector 111, which is the end layer collector 152 located at the uppermost layer, functions as an electrode collector terminal 342. That is, the electrode collector terminal 342 can be deemed as a member that constitutes the principal surface 15, i.e. the electrode collector 111 located at the uppermost layer. Meanwhile, as in the case of Embodiment 1, the counter-electrode collector terminal 41 is a member that is different from the electrode collector 111 located at the uppermost layer that constitutes the principal surface 15.

By thus causing the electrode collector 111 located at the uppermost layer to function as the electrode collector terminal 342, the number of components can be reduced.

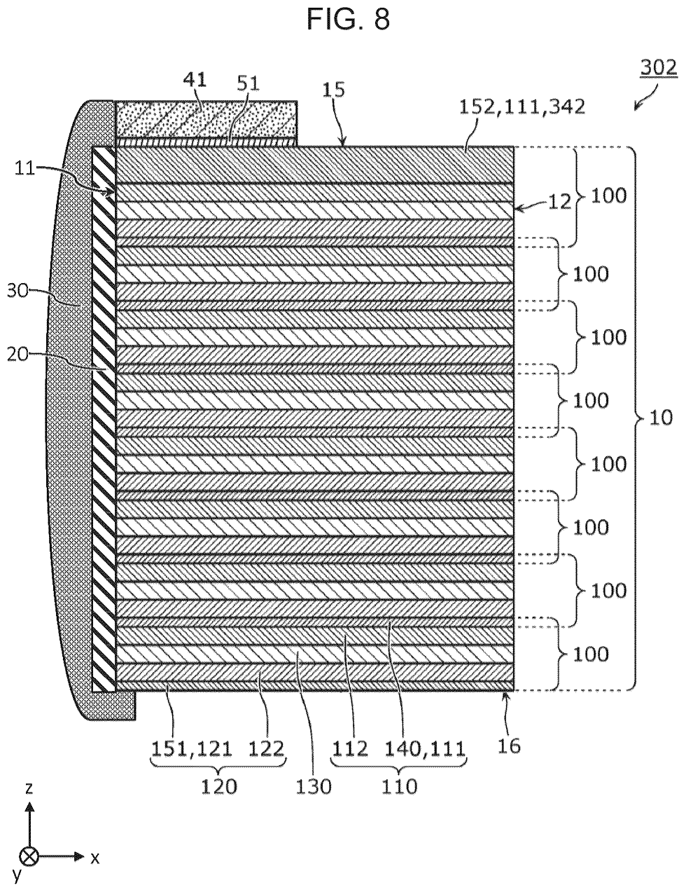

In the present embodiment, as in the case of the battery 302 shown in FIG. 8, the electrode collector 111 located at the uppermost layer may be made greater in thickness than the other intermediate layer collectors 140. This causes a decrease in resistance of the electrode collector 111 located at the uppermost layer, thus making it possible to reduce heat generated by current crowding. Alternatively, apart from thickness, the electrode collector 111 located at the uppermost layer may be made of a highly conductive material.

### Embodiment 4

The following describes Embodiment 4.

A battery according to Embodiment 4 differs from the battery 1 according to Embodiment 1 in that a side surface conductor and a counter-electrode collector terminal are integrally formed. The following gives a description with a focus on differences from Embodiment 1, and omits or simplifies a description of common features.

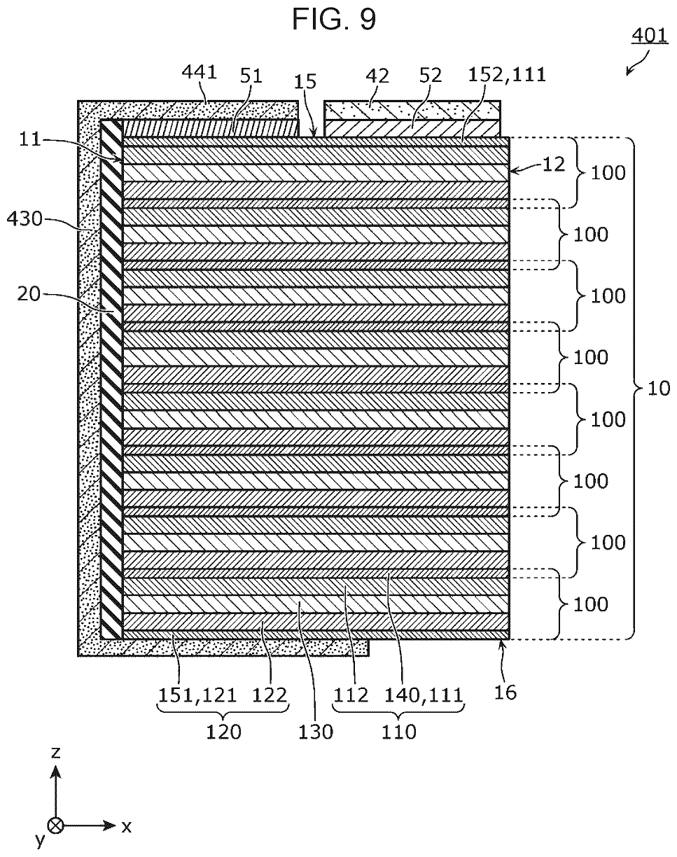

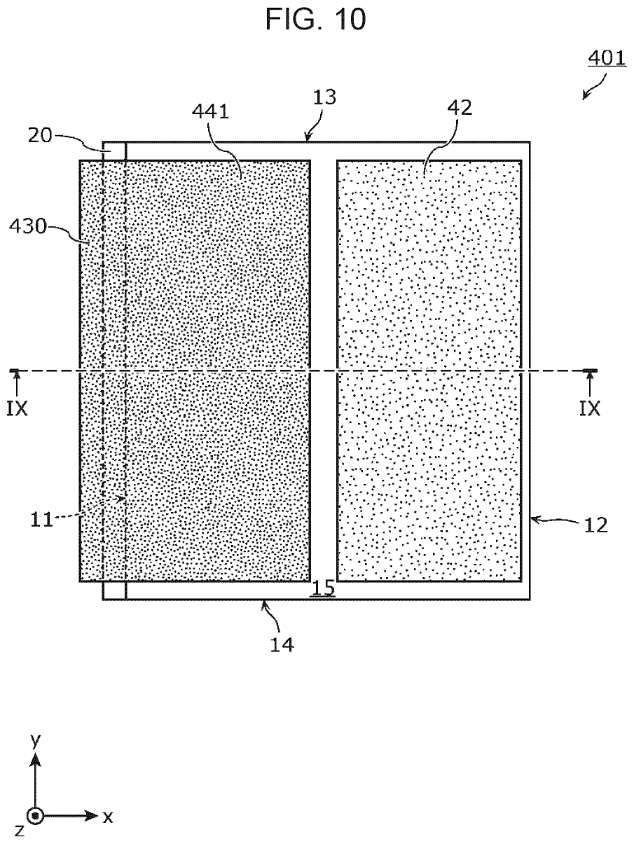

FIG. 9 is a cross-sectional view of a battery 401 according to the present embodiment. FIG. 10 is a top view of the battery 401 according to the present embodiment. It should be noted that FIG. 9 represents a cross-section taken along line IX-IX in FIG. 10. As shown in FIGS. 9 and 10, in comparison with the battery 1 according to Embodiment 1, the battery 401 includes a side surface conductor 430 and a counter-electrode collector terminal 441 instead of the side surface conductor 30 and the counter-electrode collector terminal 41.

The side surface conductor 430 and the counter-electrode collector terminal 441 are integrally configured. Specifically, the side surface conductor 430 and the counter-electrode collector terminal 441 are made of the same electrically conductive material. For example, the side surface conductor 430 and the counter-electrode collector terminal 441 are formed by folding one metal plate. More specifically, the metal plate has two folds so as to cover the principal surface 16, the side surface 11, and the principal surface 15 of the power-generating element 10. That is, the power-generating element 10 is held by the metal plate in the direction of laminating. A portion of the metal plate covering the principal surface 15 functions as the counter-electrode collector terminal 441. This makes it possible to easily form the side surface conductor 430 with high mechanical strength. Alternatively, the side surface conductor 430 and the counter-electrode collector terminal 441 may be integrally formed by joining or welding a plurality of metal plates.

Although, as shown in FIG. 10, the side surface conductor 430 and the counter-electrode collector terminal 441 are shorter in length in the y-axis direction than the side surface 11, this is not intended to impose any limitation. The side surface conductor 430 and the counter-electrode collector terminal 441 may be provided so as to jut out from the side surface 13 or 14. Further, a gap may be provided between the side surface conductor 430 and the side surface insulating layer 20. That is, the side surface conductor 430 does not need to be in contact with the side surface insulating layer 20.

### Embodiment 5

The following describes Embodiment 5.

A battery according to Embodiment 5 differs from the battery according to Embodiment 1 in that the battery according to Embodiment 1 includes a sealing member. The following gives a description with a focus on differences from Embodiment 1, and omits or simplifies a description of common features.

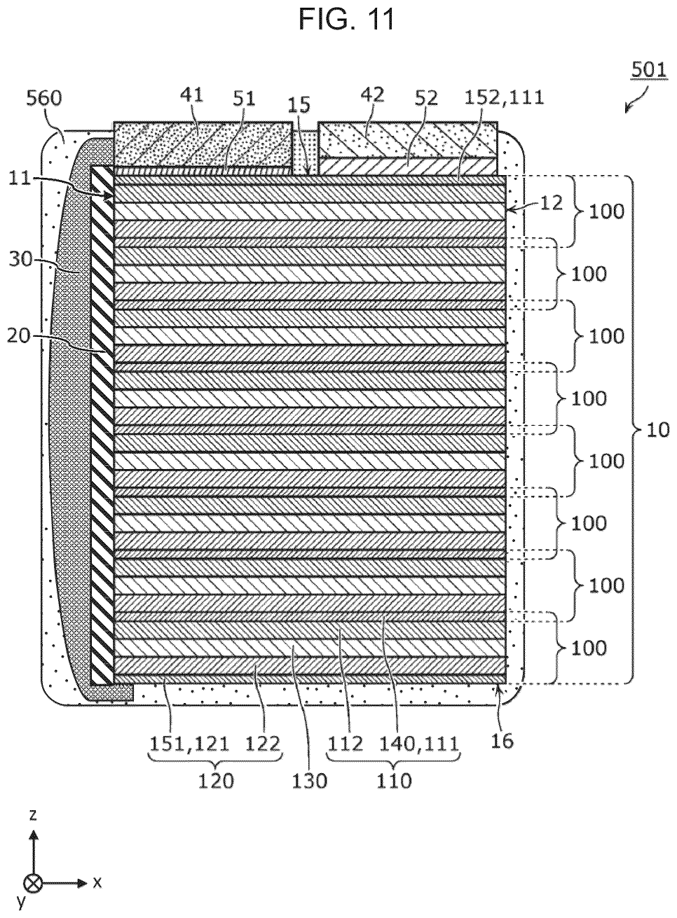

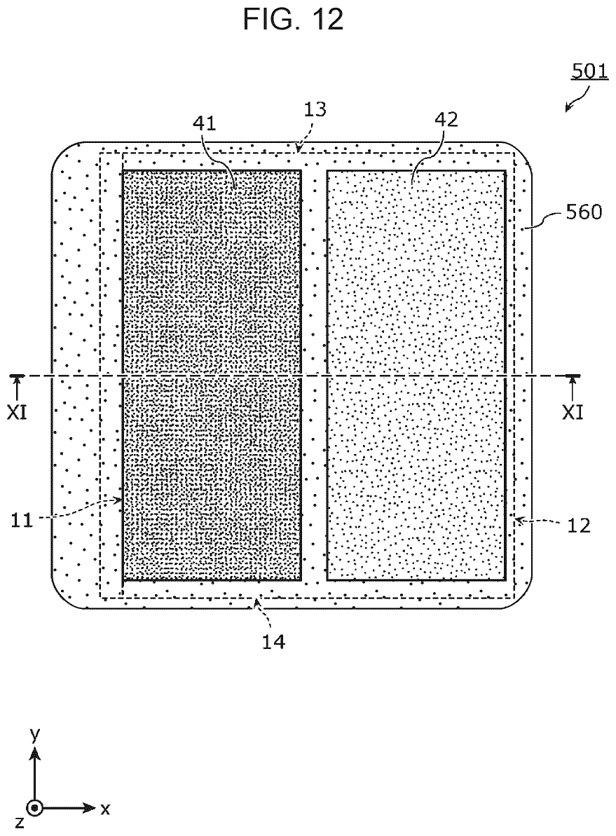

FIG. 11 is a cross-sectional view of a battery 501 according to the present embodiment. FIG. 12 is a top view of the battery 501 according to the present embodiment. It should be noted that FIG. 11 represents a cross-section taken along line XI-XI in FIG. 12. As shown in FIGS. 11 and 12, in comparison with the battery 1 according to Embodiment 1, the battery 501 includes a sealing member 560.

The sealing member 560 exposes at least part of the counter-electrode collector terminal 41 and at least part of the electrode collector terminal 42 and seals the power-generating element 10. The sealing member 560 is for example provided so that the power-generating element 10, the side surface insulating layer 20, and the side surface conductor 30 are not exposed.

The sealing member 560 is for example made of an insulating material possessing electrical insulating properties. A usable example of the insulating material is a common publicly-known material for a sealing member in a battery. A usable example of the insulating material is a resin material. It should be noted that the insulating material may be a material possessing insulating properties and not possessing ion conductivity. For example, the insulating material may be at least one of epoxy resin, acrylic resin, polyimide resin, and silsesquioxane.

It should be noted that the sealing member 560 may contain a plurality of different insulating materials. For example, the sealing member 560 may have a multilayer structure. Layers of the multilayer structure may be made of different materials and have different properties.

The sealing member 560 may contain a particulate metal oxide material. Usable examples of the metal oxide material include silicon oxide, aluminum oxide, titanium oxide, zinc oxide, cerium oxide, ferric oxide, tungsten oxide, zirconium oxide, calcium oxide, zeolite, and glass. For example, the sealing member 560 may be made of a resin material in which a plurality of particles made of the metal oxide material are dispersed.

The particle size of the metal oxide material needs only be less than or equal to a spacing between the electrode collector 111 and the counter-electrode collector 121. Examples of the particle shape of the metal oxide material include, but are not limited to, a spherical shape, an oval spherical shape, and a rod shape.

Providing the sealing member 560 makes it possible to improve the reliability of the battery 501 in various respects such as mechanical strength, short-circuit prevention, and moisture prevention.

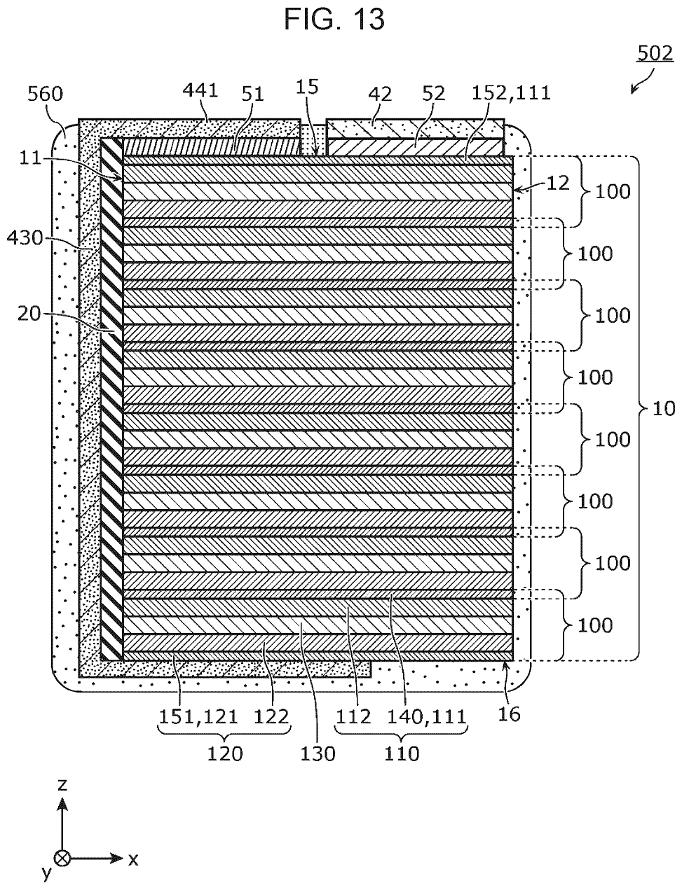

Although an example in which the battery 1 according to Embodiment 1 includes a sealing member 560 has been illustrated here, a battery according to another embodiment may too include a sealing member 560. For example, as in the case of a battery 502 shown in FIG. 13, the battery 401 according to Embodiment 4 may include a sealing member 560. FIG. 13 is a cross-sectional view of the battery 502 according to a modification of the present embodiment. In this case too, the sealing member 560 exposes the counter-electrode collector terminal 441 and the electrode collector terminal 42 and covers the power-generating element 10, the side surface insulating layer 20, and the side surface conductor 430. The sealing member 560 exposes only a portion of the metal plate constituting the side surface conductor 430 and the counter-electrode collector terminal 441 located at the principal surface 15.

### Manufacturing Method

The following describes a method for manufacturing a battery according to each of the aforementioned embodiments.

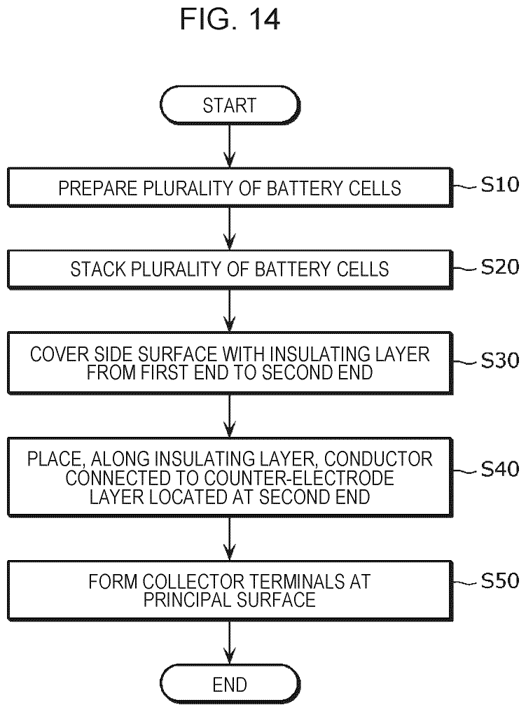

FIG. 14 is a flow chart showing an example of a method for manufacturing a battery according to each embodiment. In the following, an example of the battery 1 according to Embodiment 1 is described.

As shown in FIG. 14 first, a plurality of battery cells are prepared (S10). The battery cells thus prepared are for example battery cells 100A and 100B or 100C shown in FIGS. 3A to 3C.

Next, the plurality of battery cells 100 are laminated (S20). Specifically, a layered product is formed by laminating the plurality of battery cells 100 in sequence so that an order of arrangement of the electrode layer 110, the counter-electrode layer 120, and the solid electrolyte layer 130 of each battery cell and an order of arrangement of the electrode layer 110, the counter-electrode layer 120, and the solid electrolyte layer 130 of the other battery cell are identical. In the present embodiment, a power-generating element 10 shown in FIG. 4 is formed by laminating an appropriate combination of battery cells 100A, 100B, and 100C. The power-generating element 10 is an example of the layered product.

After the plurality of battery cells 100 have been laminated, side surfaces of the power-generating element 10 may be planarized. For example, a power-generating element 10 whose side surfaces are flat can be formed by en-bloc cutting of the layered product composed of the plurality of battery cells 100. The cutting process is executed, for example, with a cutter, a laser, or a jet.

Next, the side surface 11 of the power-generating element 10 is covered with a side surface insulating layer 20 from lower to upper ends of the power-generating element 10 (S30). The side surface insulating layer 20 is formed, for example, by coating and curing of a fluid resin material. The coating is executed by an inkjet method, a spray method, a screen printing method, a gravure printing method, or other methods. The curing is executed by drying, heating, photoirradiation, or other processes, depending on the resin material used. Alternatively, the side surface insulating layer 20 may be formed by bonding or joining an insulating plate or an insulating film to the side surface 11.

Next, a side surface conductor 30 connected to a counter-electrode layer 120 at the lower end of the power-generating element 10 is placed along the side surface insulating layer 20 (S40). For example, the side surface conductor 30 is formed by coating and curing of a conductive paste such as conductive resin so as to cover part of the principal surface 16 of the power-generating element 10 and the side surface insulating layer 20. Alternatively, the side surface conductor 30 may be formed, for example, by printing, plating, deposition, sputtering, welding, soldering, joining, thermal spraying, or other methods. The side surface conductor 30 is formed, for example, in close contact with the side surface insulating layer 20. This makes it possible to increase the energy density of the battery 1.

Next, collector terminals are formed at the principal surface 15 of the power-generating element 10 (S50). Specifically, a counter-electrode collector terminal 41 is formed over the principal surface 15 with a counter-electrode intermediate layer 51 sandwiched therebetween, and an electrode collector terminal 42 is formed over the principal surface 15 with an electrode intermediate layer 52 sandwiched therebetween. The counter-electrode collector terminal 41 and the electrode collector terminal 42 are each formed by placing an electrically conductive material such as a metallic material in a desired region by plating, printing, soldering, or other processes.

It should be noted that the counter-electrode intermediate layer 51 and the electrode intermediate layer 52 are formed, for example, by coating and curing of a fluid resin material. The coating is executed by an inkjet method, a spray method, a screen printing method, a gravure printing method, or other methods. The curing is executed by drying, heating, photoirradiation, or other processes, depending on the resin material used.

Through these steps, a battery 1 shown in FIG. 1 can be manufactured.

Each separate one of the plurality of battery cells 100 prepared in step S10 or a laminated body of the plurality of battery cells may be subjected to a step of pressing them in the direction of laminating.

Further, the counter-electrode intermediate layer 51 and the electrode intermediate layer 52 may be formed after or at the same time as the formation of the side surface insulating layer 20 in step S30. Alternatively, the counter-electrode intermediate layer 51 and the electrode intermediate layer 52 may be formed after the formation of the layered product (S20) and before side surfaces are cut.

Further, for example, in the formation of the side surface conductor 30 (S40), a side surface conductor 430 and a counter-electrode collector terminal 441 may be integrally formed by welding or joining a folded metal plate. In this case, the counter-electrode intermediate layer 51 is formed before the metal plate is connected. This makes it possible to manufacture a battery 401 shown in FIG. 9.

Further, after the formation of collector terminals (S50), a sealing member 560 shown in FIGS. 11, 12, and 13 may be formed. The sealing member 560 is formed, for example, by coating and curing of a fluid resin material. The coating is executed by an inkjet method, a spray method, a screen printing method, a gravure printing method, or other methods. The curing is executed by drying, heating, photoirradiation, or other processes, depending on the resin material used.

### Other Embodiments

In the foregoing, a battery and a method for manufacturing a battery according to one or more aspects have been described with reference to embodiments; however, the present disclosure is not intended to be limited to these embodiments. Applications to the present embodiments of various types of modification conceived of by persons skilled in the art and other embodiments constructed by combining some constituent elements of different embodiments are encompassed in the scope of the present disclosure, provided such applications and embodiments do not depart from the spirit of the present disclosure.

Further, for example, although the foregoing embodiments have illustrated an example in which one collector is shared as an intermediate layer collector between adjacent battery cells, the collector does not need to be shared. A counter-electrode collector and an electrode collector may be joined on top of each other to constitute an intermediate layer collector.

Further, for example, side surface insulating layers and side surface conductors may be provided at two or more side surfaces of a power-generating element. For example, side surface insulating layers and side surface conductors may be provided at all of the four side surfaces of a power-generating element.

Further, each of the foregoing embodiments is subject, for example, to various changes, substitutions, additions, and omissions in the scope of the claims or the scope of equivalents thereof.

The present disclosure is applicable to batteries for electronics, electrical appliances, electric vehicles, or other devices.

What is claimed is:

1. A battery comprising:
a power-generating element including a plurality of battery cells each including an electrode layer, a counter-electrode layer, and a solid electrolyte layer located between the electrode layer and the counter-electrode layer, the plurality of battery cells being electrically connected in series and laminated;
a side surface insulating layer covering a side surface of the power-generating element from first to second ends of the power-generating element in a direction of laminating;
a side surface conductor both connected to a counter-electrode layer located at the second end of the power-generating element and disposed along the side surface insulating layer;
a counter-electrode collector terminal, both disposed at a first principal surface of the power-generating element located at the first end and connected to the side surface conductor, that is greater in thickness than a collector connected to the counter-electrode layer located at the second end; and
an insulating layer disposed between the counter-electrode collector terminal and the first principal surface.

2. The battery according to claim 1, further comprising an electrode collector terminal disposed at the first principal surface and connected to an electrode layer located at the first end.

3. The battery according to claim 2, further comprising an intermediate layer disposed between the electrode collector terminal and the first principal surface.

4. The battery according to claim 2, wherein a height of the counter-electrode collector terminal from the first principal surface and a height of the electrode collector terminal from the first principal surface are equal to each other.

5. The battery according to claim 2, wherein the counter-electrode collector terminal and the electrode collector terminal are arranged in this order along a direction away from the side surface in a planar view of the first principal surface.

6. The battery according to claim 2, wherein the counter-electrode collector terminal surrounds the electrode collector terminal in a planar view of the first principal surface.

7. The battery according to claim 2, further comprising a sealing member that exposes at least part of the counter-electrode collector terminal and at least part of the electrode collector terminal and seals the power-generating element, the side surface insulating layer, and the side surface conductor.

8. The battery according to claim 1, wherein
each of the plurality of battery cells includes a collector,
the electrode layer located at the first end includes an electrode collector, and
a thickness of the electrode collector is greater than a thickness of a collector included in one of the plurality of battery cells.

9. The battery according to claim 1, wherein the side surface conductor further covers a second main surface of the power-generating element located at the second end.

10. The battery according to claim 9, wherein the side surface conductor is a metal plate.

11. The battery according to claim 10, wherein the counter-electrode collector terminal is part of the metal plate.

12. The battery according to claim 1, wherein the side surface insulating layer contains resin.

13. The battery according to claim 1, wherein the side surface conductor is greater in thickness than the collector connected to the counter-electrode layer located at the second end.

14. A method for manufacturing a battery, the method comprising:
preparing a plurality of battery cells each including an electrode layer, a counter-electrode layer, and a solid electrolyte layer located between the electrode layer and the counter-electrode layer;
forming a layered product by laminating the plurality of battery cells so that an order of arrangement of the electrode layer, the counter-electrode layer, and the solid electrolyte layer of every one of the plurality of battery cells and an order of arrangement of the electrode layer, the counter-electrode layer, and the solid electrolyte layer of another of the plurality of battery cells are identical;
covering a side surface of the layered product with an insulating member from first to second ends of the layered product;
placing, along the insulating member, a conductor connected to a counter-electrode layer located at the second end of the layered product; and
providing, via an insulating layer at a principal surface of the layered product located at the first end, a counter-electrode collector terminal connected to the conductor.
